(19) United States
(12) Patent Application Publication
(10) Pub. No.: US 2007/0218438 A1
(43) Pub. Date: Sep. 20, 2007

(54) Tracheotomy teaching aid

(76) Inventors: Jerrie L. Sanders, Rochester, NH (US); Renee Williams, Ridgeland, MS (US); Sylvia M. Hilton, Pearl, MS (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(21) Appl. No.: 11/378,709

(22) Filed: Mar. 17, 2006

(51) Int. Cl. G09B 19/00

(52) U.S. Cl. 434/236

(57) ABSTRACT

A system, method, and device for practicing tracheotomy tube maintenance are disclosed. The exemplary system may have a simulated head and neck section. The simulation may be a form hollow body of semi-rigid material with an internal cavity that simulates a human airway between a mouth and a neck of the human with a tracheal stoma in the neck. The tracheal stoma is sized to receive a tracheotomy tube. An aperture in the neck may be provided to allow a user to view the placement of the tracheotomy tube in the internal cavity.

### TECHNICAL FIELD

The present invention relates to tracheotomy and more particularly, relates to a teaching aid to simulate the placement of tracheostomy tubes and airway care.

### BACKGROUND INFORMATION

A tracheotomy may be performed to provide a bypass to an obstructed upper airway. The tracheotomy allows the cleaning and removal of secretions from the airway. The tracheotomy may provide safer delivery of oxygen and/or ventilation via a tracheostomy tube to the lungs in some patients. The surgeon makes an incision low in the neck. An opening is produced in the trachea to allow for an artificial airway through the neck or upper chest below the voice box (larynx). Referring to FIG. 1, a stoma 100 with a tracheostomy tube 102 is inserted to allow the passage of air.

Tracheostomy tubes are inserted in the airway of the patient to permit breathing when the airway has been blocked, damaged or when the lungs are compromised by disease. Tracheostomy tubes are inserted in the neck of the patient and include an internal portion, which extends into the trachea, and the outer end of the tracheostomy tube is provided with a flange and a support plate located externally of the patient having an opening therein communicating with the tube through which air is inhaled. Some tracheostomy tubes have a unidirectional valve that extends from the tracheotomy tube flange and support plate.

Practice mannequins have been used as teaching aids for cardiopulmonary resuscitation (CPR). The mannequins simulate the head, lungs and thorax of a human being. The thorax has the structure of foam and is made of a flexible elastic material. A spring means is disposed in the thorax simulation to simulate the compression resistance of the thorax. The lung simulation is a flat bag, which is communicated with a oral opening of the head simulation. The lung bag is disposed in the thorax in such a way that when air is blown into the bag, the bag causes a visible lifting movement of the anterior and lateral section of the thorax. The mannequins may simulate a blockage of the airway and thus ineffective respiration. The face simulation allows a user to perform mouth-to-mouth respiration. The user learning or practicing the procedure must occlude nostrils of the face simulation by pinching them closed.

It may be desirable for patients along with caregivers to have the opportunity to practice inserting and removing the tracheostomy tube for routine maintenance. It may also be desirable for patients and caregivers to observe signs of potential problems that may require professional medical attention. Accordingly, a need exists for a device, method, and system that allows patients and caregivers the opportunity to practice inserting and removing the tracheostomy tube without danger of harming the patient. The device, method and system may allow patients and caregivers to check for signs of potential problems and/or remove an obstruction.

### SUMMARY

The present invention is a novel device, system, and method for a teaching aid for practicing tracheostomy tube maintenance. An exemplary embodiment, according to the present invention, may provide a simulated head and neck section. The simulated head and neck is a form hollow body of semi-rigid material with an internal cavity that simulates a human airway between a mouth and a neck of the human with a tracheal stoma in the neck. The tracheal stoma may be sized to receive a tracheostomy tube. An aperture in the neck may allow a user to view the placement of the tracheostomy tube in the internal trachea.

Alternate embodiments may include one or more of the following. A sensor may be provided for determining proper or improper placement of the tracheostomy tube within the tracheal stoma and the trachea. An alarm may signal a user of the improper placement detected by the sensor. In another embodiment, the simulated head and neck section is of an infant or a pediatric head and neck. In another embodiment, a fluid dispensing device may produce fluid around the tracheal stoma to simulate secretions from the trachea. In another embodiment, a blockage device may temporarily block the trachea to simulate airway obstruction. In yet another embodiment, a blockage sensor may determine a blockage of the airway. A timer may be activated when the blockage sensor detects a blockage and an alarm may signal a user when the timer reaches a predetermined time.

It is important to note that the present invention is not intended to be limited to a system or method which must satisfy one or more of any stated objects or features of the invention. It is also important to note that the present invention is not limited to the exemplary embodiments described herein. Modifications and substitutions by one of ordinary skill in the art are considered to be within the scope of the present invention, which is not to be limited except by the claims stated later herein.

### BRIEF DESCRIPTION OF THE DRAWINGS

These and other features and advantages of the present invention will be better understood by reading the following detailed description, taken together with the drawings wherein:

FIG. 1 is a perspective view of a stoma.

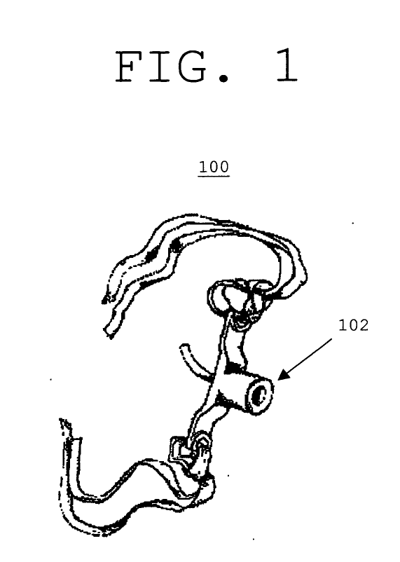

FIG. 2 is a top profile view of a head and neck section according to an exemplary embodiment.

FIG. 3 is a side profile view of a neck section according to the exemplary embodiment.

FIG. 4 is a bottom profile view of a neck section according to the exemplary embodiment.

### DETAILED DESCRIPTION

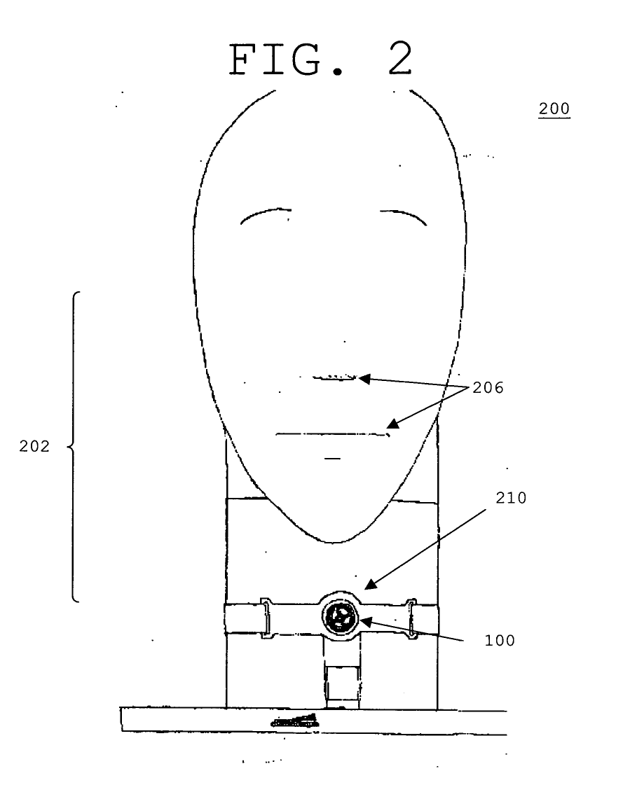

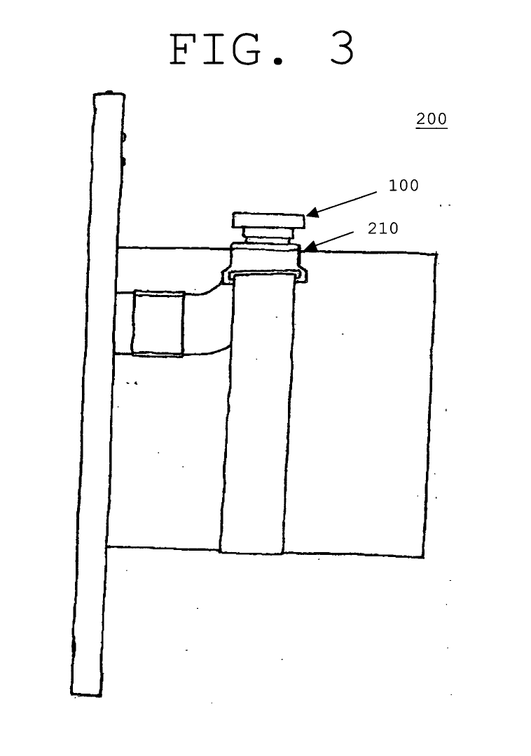

Referring to FIGS. 2, 3 and 4; a mannequin 200 has a head and neck section 202. The head and neck section 202 may have an internal cavity 204 that resembles the pharynx and trachea of a human. The internal cavity 204 connects a nose and/or mouth opening 206 in the head of the mannequin 200 to a throat and lower trachea in the neck of the mannequin. A tracheotomy opening 210 is provided in the neck of the mannequin 200 to connect to the internal cavity 204. The tracheotomy opening 210 may be sized and shaped to resemble a typical tracheal stoma.

The mannequin 200 allows a patient or caregiver to practice caring for a tracheal stoma. The care may include, for example, inserting and removing a tracheostomy tube and/or inner cannula, clearing an obstruction, artificial resuscitation, suctioning techniques of the trach tube or stoma, dressing, cleaning and maintenance of the tracheal stoma opening, and detecting signs of problematic symptoms. The mannequin 200 allows a user of the mannequin 200 to practice under the supervision of a professional without the dangers or pressure in actually performing the procedure on a living individual. The user may practice multiple times and gain skill and confidence prior to attempting the procedures on a living individual.

The mannequin 200 has a head and neck section 202 constructed to resemble a human head and neck. The head and neck section 202 may be constructed with a semi-rigid foam to mimic the firmness of the human body. The foam may be covered with a plastic film to simulate skin and provide exterior protection for the mannequin 200. The mouth 206, nose 206, and the tracheal stoma 210 may be made of flexible plastic material to simulate tissue of the respective tissues. The neck may be designed to simulate the rigidness of human neck muscles. The mannequin 200 is not limited to having a head and neck portion 202. The mannequin 200 may have a simulated body or just have a neck section without the head. The mannequin 200 may also be incorporated in other learning aid mannequins, for example, a CardioPulmonary Resuscitation (CPR) mannequin.

In practice the user inserts a tracheostomy tube 102 into the tracheal stoma 210. The tracheostomy tube 102 slides through the stoma 210 into the trachea. Sensors (not shown) may be provided that sense the positioning of the tracheostomy tube 102 within the trachea. The sensor may be contact, pressure, or a photo sensor that transmits a signal to a processing unit (not shown). The processing unit may activate an alarm 212 to signal the user of the correct or incorrect insertion of the tracheostomy tube 102. For example, the alarm 212 may be a series of lights. A green light may indicate that the tracheostomy tube 102 is being positioned correctly. A red light may indicate that the user is incorrectly cannulating the stoma 100, which is causing the tracheostomy tube 102 to apply incorrect pressure. The alarm 212 is not limited to lights. The alarm 212 may be a display, audible signal, or a variety of other signaling devices to communicate to the user.

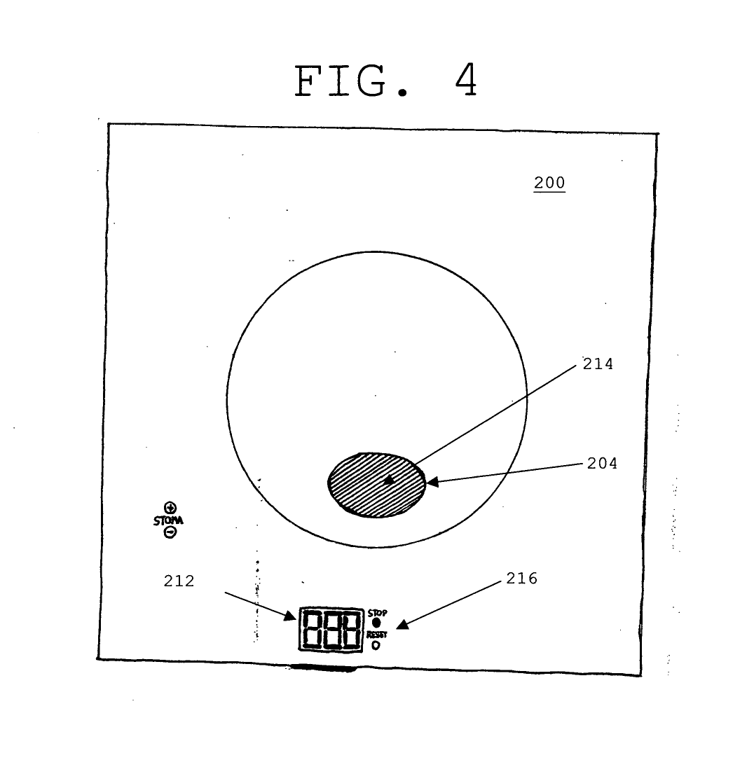

The mannequin 200 is not limited to sensors for determining proper placement by the user. A window 214 may be provided at the base of the mannequin 200 as shown in FIG. 4. The window 214 may allow the user to see into the lower section of the internal cavity 204 that simulates the trachea. As the tracheostomy tube 102 is positioned into the trachea cavity 204 of the mannequin 200, the user may observe through the window 214 the placement of the tracheostomy tube 102. The user may observe correct or incorrect placement of the tracheostomy tube 102. An instructor may use the window 214 to demonstrate how and why the positioning of the tracheostomy tube 204 is incorrect or correct. The window 214 may be open or covered with a transparent material.

The processing unit may also have a clock that may be used to determine incorrect timing of techniques. For example, placement of the trach tube 100 may need to be accomplished within a set period due to the patient's inability to breath or maintain the airway while the trach tube is being inserted 100. The processing unit may activate an alarm if a user has not correctly positioned the trach tube 100 within a predefined period. In this example a start and stop button 216 may be provided to allow the user to communicate when the technique is initiated or completed. In another example sensors may be used to determine when the technique has been initiated and/or when the technique is completed. The sensor may be designed to simulate when a living person would be unable to breath during the technique. The alarm would indicate when discomfort or danger to an individual occurs after a period of time during which the technique is being performed.

In another example, the mannequin 200 may have a fluid dispensing device. The fluid dispensing device may eject fluid to simulate pulmonary secretions around the tracheal stoma 210. The fluid dispensed by the device may be water or other fluid that may provide realistic simulation while not necessitating extensive cleanup. The user may practice various suction techniques on the mannequin 200 related to care of the tracheal stoma and airway 210.

In another example, the mannequin 200 may have a blockage device. The blockage may be an object in the trachea 204 that requires a user to simulate removal of airway obstruction. The blockage may be designed to simulate common blockages typical in an airway obstruction. For example, a plastic silicone or widget in the trachea 204 may simulate a mucous plug that could obstruct the airway. The user may practice techniques for clearing the obstruction.

In another example, the surface of the mannequin 200 may be colored or textured to simulate different symptoms a user should identify as needing medical attention. The surface may be changeable to allow users to witness different symptoms. Other modifications and substitutions by one of ordinary skill in the art are considered to be within the scope of the present invention, which is not to be limited except by the following claims.

The invention claimed is:

1. A teaching aid for practicing tracheotomy tube maintenance comprising:
a simulated head and neck section wherein the simulation is a form hollow body of semi-rigid material with an internal cavity that simulates a human airway between a mouth and a neck of the human with a tracheal stoma in the neck;
the tracheotomy opening wherein the tracheal stoma is sized to receive a tracheotomy tube; and
an aperture in the neck wherein a user may view the placement of the tracheotomy tube in the internal cavity.

2. The teaching aid for practicing tracheotomy tube maintenance of claim 1 further comprising:
a sensor for determining improper placement of the tracheotomy tube within the tracheotomy opening and the internal cavity and an alarm for signaling a user of the improper placement detected by the sensor.

3. The teaching aid for practicing tracheotomy tube maintenance of claim 1 wherein the simulated head and neck section is of an infant head and neck.

4. The teaching aid for practicing tracheotomy tube maintenance of claim 1 wherein the simulated head and neck portion is of a pediatric head and neck.

5. The teaching aid for practicing tracheostomy tube maintenance of claim 1 further comprising:
a fluid dispensing device for producing fluid around the tracheotomy opening to simulate secretions from the trachea and lungs.

6. The teaching aid for practicing tracheotomy tube maintenance of claim 1 further comprising:
a blockage device for blocking the internal cavity to simulate tracheal obstruction.

7. The teaching aid for practicing tracheostomy tube maintenance of claim 1 further comprising:
a blockage sensor to detect a blockage of the internal cavity;
a timer activated when the blockage sensor detects a blockage; and
an alarm for signaling a user wherein the alarm is activated when the timer reaches a predetermined time.

8. A mannequin for teaching tracheotomy care comprising:
a neck section wherein the simulation is a form hollow body of plastic material with an internal cavity that simulates a human airway between an upper neck and a lower neck of a human with a tracheal stoma in the neck;
the tracheal stoma wherein the tracheal stoma is sized to receive a tracheotomy tube;
a sensor for determining improper placement of the tracheotomy tube within the tracheal stoma and the internal cavity; and
an alarm for signaling a user of the improper placement detected by the sensor.

9. The mannequin for teaching tracheotomy care of claim 8 further comprising:
an aperture in the lower neck wherein a user may view the placement of the tracheotomy tube in the internal cavity.

10. The mannequin for teaching tracheotomy care of claim 8 wherein the simulated neck section is of an infant neck.

11. The mannequin for teaching tracheotomy care of claim 8 wherein the simulated neck section is of a pediatric neck.

12. The mannequin for teaching tracheotomy care of claim 8 further comprising:
a fluid dispensing device for producing fluid around the tracheal stoma to simulate secretions from the trachea and lungs.

13. The mannequin for teaching tracheostomy care of claim 8 further comprising:
a blockage device for blocking the trachea to simulate airway obstruction.

14. The mannequin for teaching tracheotomy care of claim 8 further comprising:
a blockage sensor to detect a blockage of the internal cavity;
a timer activated when blockage sensor detects a blockage; and
an alarm for signaling a user wherein the alarm is activated when the timer reaches a predetermined time.
